(19) United States
(12) Patent Application Publication
(10) Pub. No.: US 2014/0275364 A1
(43) Pub. Date: Sep. 18, 2014

(54) NONTOXIC INK

(71) Applicant: Marcela Yolanda Cozzo Barboza, Montevideo (UY)

(72) Inventor: Marcela Yolanda Cozzo Barboza, Montevideo (UY)

(73) Assignee: JEPORU S.A., Montevideo (UY)

(21) Appl. No.: 14/238,515

(22) PCT Filed: Jul. 30, 2012
(86) PCT No.: PCT/BR2012/000270

§ 371 Date: May 28, 2014

(30) Foreign Application Priority Data
Aug. 12, 2011 (UY) 33.555

(51) Int. Cl. C09D 11/00

(52) U.S. Cl. CPC C09D 11/00
USPC 524/111

(57) ABSTRACT

“NONTOXIC INK SUITABLE FOR ARTISTIC OR DIDACTIC EXPRESSION” of this invention patent application relates to an ink comprising a water-based, cosmetic-type emulsion, a vinyl resin emulsion, pigments, mineral load, aromatic essences, an emulsifying agent, preservative agents, water and optionally varied particle size distribution elements (texturizers), all of them in an aqueous phase. The ink object of this invention patent application is suitable for artists in general, especially to visually impaired people, children in pre-school age and to every user requiring preferably chemically harmless inks, both in contact with skin and mucous membranes, as the possible inadvertent ingestion.

This invention patent application relates to a nontoxic ink suitable for artistic or didactic expression, comprising a water-based, cosmetic-type emulsion, a vinyl resin emulsion, pigments, mineral load, aromatic essences, an emulsifying agent, preservative agents, water and optionally varied particle size distribution elements (texturizers), all of them in an aqueous phase. The ink object of this invention patent application is suitable for artists in general, especially to visually impaired people, children in pre-school age and to every user requiring preferably chemically harmless inks, both in contact with skin and mucous membranes, as the possible inadvertent ingestion.

### BACKGROUND OF THE INVENTION

The previous chemical state of the art on manufacturing and usage of the inks has accumulated great experience and knowledge in human culture. Either to cover, decorate, protect surfaces or to produce works of arts, the state of the art has generated a great amount of products that were suitable so far to meet the cultural needs in such a wide fields that includes architecture, drawings, art, pedagogy and didactics as stimulating element of artistic expression in young children.

The chemical state of the art defines an ink as a product with different grades of viscosity that when applied by extension, projection or immersion over an object or stuff, cover, project or make it colored.

The standard formulas of the modern inks have several categories of chemical compounds: dyes or pigments, solvents or diluents, binders, emulsifiers, loads, preservatives, and sometimes some materials are added in order to catalyze or speed up the ink drying. A subset of these compounds with very own characteristics features those inks designated to art expression.

Within the broad family of suitable ink for artistic expression, different emulsions are known that may be used as a base for preparing colored compounds or mixtures useful to express or stimulate pictorial art.

Inks to oil-resin-type tempered artistic use, stable, of great aesthetic nature, with emulsifiers that increases its miscibility, including watercolors and tempera (ES 2 192 987 A1) were developed. Other developments pointed out to the creation of glycols-based dyes folders (36% weight) (ES 2 019 038) generating useful products to inks, or lacquers or epoxy resins-based inks, the ink priming intended for steel, wood, plastic or similar. However, these folders do not present neither a texture nor mechanical features suitable for the desired art development in this present invention patent application, besides comprising a weight percentage of glycols that make them harmful to human health both as by inhalation as by contact or ingestion. That is an important inconvenient when it is intended to that such inks are also useful for stimulating the artistic expression in young children.

The present invention patent application addresses to the outline of a formulation to be used as inking to artistic expression of groups of people that perceive their possibilities to express themselves artistically as being diminished, such as visually impaired people, or the ones requiring a didactic product to stimulate such expression, such as children in pre-school age, or with psychological or psychiatric impairments.

Such kinds of products, as the ones in the present invention patent application, require particular properties: i) safety to contact and/or unintentional ingestion; ii) identification upon aromatic and/or textures, allowing generating an identification code between color-aroma-environment; iii) mechanical plasticity to allow its hand application or to ease the usage of the Constanz System which allows a visually impaired person to recognize by touch a codified surface with embossed sings with characteristic shapes; all that allows the coherent expression of an artistic scene performed and interpreted among visually impaired people. The same properties may be used with pedagogical and didactical sense by children in pre-school age whose artistic expression is desired to be stimulated.

Accordingly, the products to inks of the present invention patent application come from the integration of the plasticity provided by a cosmetic emulsion with the coverage properties of an aromatic artistic ink with ductile and thick consistency.

Particularly, a preferred usage of the ink formulation of the present invention patent application is the group of visually impaired people. Nowadays, this group of people sees their possibilities of expressing themselves artistically very diminished. Furthermore, it is very difficult for them to access inking as viewers due to their visually impairment. In all cases, it becomes imperative the dependence of someone with good vision to provide them inks with different colors or to report them what they see in an artistic scene.

The present invention patent application provides a formulation to ink that allows the visually impaired people a way to connect with the colors and with the art expression through their unaffected senses by their visual impairment: the sense of smell and touch.

In this sense, the present invention patent application provides a formulation to artistic or didactic ink with duly controlled sanitary quality, thick, ductile, aromatic and adherent over several materials such as wood, metal, glass, cardboard or textile fiber.

In a first aspect of the present invention patent application, a formulation to thick artistic or didactic ink, aromatic and ductile is provided, which to each color different aromatic products are added. The plasticity is obtained with the combination of the binder agent (vinyl polymer or water-soluble acrylics) with the mineral load (calcium carbonate) that provides a very special consistence or viscosity, and that allows the visually impaired artist, even when the ink is still wet, to impress, draw or “write” over their works or artistic inks characteristic slots or signs, such as the Constanz System previously known in the art, characterizing, therefore, the different colors. The Constanz System was created by the Colombian artist Constanza Bonilla so that a visually impaired person may recognize the colors by touch through an “alphabet” that assigns to each color its characteristic symbol. It produces an aroma-color-symbolism synergic effect.

Optionally, the mixture of the previous paragraph may be further additive with different, forms and particle size distribution (“texturizer compound”) materials which allow an additional correlation code between aroma and color, added herein by the additional texturizer compound that allow that the ink, once dry and without its remaining aroma, may be distinguishable also by through its different textures.

Such synergic effects, aroma-color-symbolism or aroma-color-texture-symbolism are obtained in a sole act only with the innovative ink disclosed in the present invention patent application. For a visually impaired artist or a child in pre-school age, such synergies do not require more than creating a color-aroma-symbolism-texture correspondence and the learning of said convention that join them. Thus, in the case of visually impaired people, after having managed to ink a inking autonomously, they may share their work with other visually impaired people when the color code is impressed in the ink itself. It constitutes a very powerful tool that provides to visual impaired people a complete independence to express themselves through the art.

It was not enough to pack a common ink with tags written in Braille Code, once, when inking, the artists put the inks in other containers when they are creating their own color palette, which may lead to a loss of those colors identification. Accordingly, this first aspect of the present invention patent application also allows solving such difficulty to visually impaired artists. The aromatic traceability of the inks of the present invention patent application ensures the permanent color identification.

Furthermore, in this same aspect of the present invention patent application, in a skillful visually impaired artist, the color-aroma synergy would allow to create a color palette with greater polychromatic possibilities under a skilled and refined recognition of the aroma mixtures.

In this same aspect of the present invention patent application, the ink formulation obtains a great flexibility in the inked layer. This is accomplished by using as a base of the ink a cosmetic emulsion, which grants to the produced artistic expression a set of mechanical properties which finishing results comparable to that ones in embossed mural, but at the same time retain certain grade of humidity, the flexibility enough to be able to put the work coiled into transportation tubes not incurring into breaks or fractures onto the artistic ink layer extended over the supporting material, nor in the supporting material itself, such as, for instance, a textile material.

In a second aspect, the present invention patent application provides a formulation to artistic or didactics ink sanitarily innocuous because it does not have any compound potentially toxic. The formulation compounds, which is further described, were carefully selected and formulated in such concentrations that ensure and warrant its safety regarding the toxicity, considering particularly the usage and application possibility by the user's hand, or its contact with the skin or with the mucous membrane, or the involuntary or inadvertent ingestion possibility. Therefore, the ink formulation of the present invention patent application is particularly useful to children in pre-school age.

In a third aspect, the present invention patent application provides a formulation to artistic or didactic ink with good adhesion over different surfaces, such as wood, metal, glass, cardboard, plastic or textile fibers. The incorporation in the formulation of a vinyl or acrylic glue, chosen among those commercially available, but with nontoxic compounds, with adhesive agents, grant to the ink innovative and potential usages. For example, it would provide to a children's toy manufacturer, or other objects for the usage of visually impaired people, the possibility of such objects to be inked with the inks of the present invention patent application, as long as the color code of the Constanz System appears on their different surfaces.

### DESCRIPTION OF THE FORMULATION

The present invention patent application discloses a formulation to artistic or didactic ink with controlled sanitary quality, thick and ductile, aromatic and adherent, whose characteristics and usages are as described in the previous paragraphs.

From now on, the word “ink”, as employed herein, relates to a composition or mixture of different chemical compounds that forms oil to water emulsion, homogeneous and stable, with viscosity suitable to be extensible over any surface in order to cover, protect and decorate it without the necessity of adding any type of solvent.

The sentence “artistic expression” or “didactic expression”, as it is used herein, relates to the result of ornamental and/or decorative nature resulting from the application or the incorporation of the ink of the present invention patent application over a surface to which a special appearance is granted.

The expression “cosmetic emulsion” as it is used in the present invention patent application must be understood as a emulsified system from an oily phase in a continuous aqueous phase (olive/water) with the pH controlled between 6.5 and 7, stabilized with surfactant agent, chemically inert and without toxic or harmful compounds to human health.

Particularly, the formulation of the present invention patent application comprises:

(i) a cosmetic emulsion containing at least one emulsifier or emulsifier, and a solvent;

(ii) a vinyl or acrylic emulsion;

(iii) an aromatic essence;

(iv) at least one dying pigment or mixture of them;

(v) at least one load agent;

(vi) at least one preservative agent;

and, in some embodiments, optionally,

(vii) an additional inert texturizer.

The inks of the present invention patent application contain a cosmetic emulsion (i) as a base, support or vehicle of the formulation, a particularly innovative aspect due to the fact that there is no background found that have been conceived, outlined nor formulated an ink with artistic purposes having a cosmetic emulsion as a base, support or vehicle with sufficient humidity and oiliness, chemically inert and sanitarily innocuous, which result in a combination with the vinyl or acrylic aqueous emulsion (ii) produces a new joint emulsion (i+ii), that grants to the formulation the plasticity and the shine, and produces a final film of ink over the inked surface with the characteristics required to be considered a work of art or a stable artistic expression as time goes by.

The stability of such mixture (i+ii) is a synergic consequence, especially useful to the didactic and/or professional artist expression.

The cosmetic base or vehicle of the inks of the present patent application has, in turn, an oil or fat or a mixture of both, water and a emulsifier. The oils or fats useful to the ink of the present invention patent application are selected from the consisting group, but with no limitation, of glyceryl monostearate, cetostearilic alcohol, cetyl alcohol, silicones, isopropyl myristate, vaseline, ethoxylated lanolin, acetylated lanolin alcohol, acetylated and ethoxylated lanolin alcohol, stearic acid, lanolin, linseed oil and vegetable oil. In the preferred embodiment of the ink of the present invention patent application, it was selected a glyceryl monostearate and cetostearilic alcohol mixture due to the fact that these products would provide to the ink of the present invention patent application the proper texture to the desired usage and, additionally, because none of them has its own aromas that may interfere in an inacceptable way with the aromas especially added to the formulation.

This mixture in the ratio that will be further disclosed was the one that demanded a lower amount of additional water in order to reach, with the other compounds of the formulation, the desired viscosity to the ink. This decrease in the amount of water in the final emulsion provided to the ink the additional advantage of a shorter dry time, maintaining the plasticity, without the necessity of adding additional drying catalysts, drying agents, generally toxics, maintaining the “safety” characteristic of the final product.

In such conditions, the preferred glyceryl monostearate and cetostearilic alcohol mixture has showed a drying time decrease both in its application in a thin layer (0.008 g/cm²) as in a thick layer, 2.5 times more of ink load (0.02 g/cm²), upon controlled environment humidity conditions and support. This important property distinct from the ink formulation of the present invention patent application and its proof are further described in Example 2.

The emulsifying agents suitable for the inks of the present invention patent application were selected from a group of emulsifiers formed by those that favor the oil in water emulsion, due to the fact that, being a mixture with a resin aqueous emulsion, the water ratio in the emulsion (i+ii) results higher than the oily material, being the water the continuous phase and the oil micelles the disperse phase. Examples of the useful emulsifiers to the inks in the present invention patent application are the glycerides of fatty acids, phospholipids of soybean lecithin, sucrose esters, polyglycerol polyricinoleate, propylene glycol esters of fatty acids, stearyl-2-lactic acid, stearyl tartrate and calcium or sodium caseinates.

The preferred emulsifiers to the inks of the present invention patent application are the mono and diglycerides of fatty acids that must be ethoxylated in order to favor the oil in water emulsions, such as the ones in the present invention patent application. The usage of this kind of emulsifier has shown an industrial certainty in its function as emulsifiers and has also shown that it has an extremely low level of toxicity. In a preferred embodiment of the ink of the present invention patent application, the emulsifying agent may be the polyoxyethylene sorbitan monostearate, polyoxyethylene sorbitan monolaurate, polyoxyethylene sorbitan monopalmitate, polyoxyethylene sorbitan tristearate or mixtures thereof. In a more preferred embodiment of the ink of the present invention patent application, the emulsifier is a polyoxyethylene sorbitan monooleate.

The inks of the present invention patent application have a vinyl or acrylic emulsion (ii) according to the previously described. The proper type of resin emulsion must provide to the ink good mechanical properties, generating a final neither non-crack nor breakable and very flexible layer, and with high adherence to the covered surface. The ink of the present invention patent application may be produced with both types of resin, although not limiting the reach of the formulation, a preferred embodiment is the usage of vinyl-type resins, such as vinyl glues commercially available, even more preferable, an emulsion of vinyl acetate homopolymer. Additionally, the emulsion (ii) behaves and acts as a binder agent carrier of the oily greasiness of the cosmetic emulsion (i), of the viscosity obtained with the load agent (v) and the color obtained with the pigments (iv). Also in addition, this emulsion (ii) acts as an adherent agent providing the adherence necessary to a ink to any of the materials mentioned in this document herein.

Although the investigation and the development of the present formulation of the ink do not have been directed to the proof and demonstration that the synergic effect of the emulsion mixture (i) and (ii) will also apply to include the fact that it was not necessary to add binder agents, adherents and drying catalysts, as it is a practice in the previous art in this industrial art, it seems to be a reasonable and justifiable doubt that it was that way. Despite this lack of proof, the same fact of the behavior previously described is sufficient to generate a composition whose formulation, by not requiring additional generally toxic agents, allowed achieving an innocuous formulation, also suitable for visually impaired users and/or children in pre-school age.

The inks of the present invention patent application have aromatic and visual products whose synergy among them produces unexpected effects upon the users, such as visually impaired people. The pigments (iv) used may be both organic and inorganic, with high light-resistance, high color stability throughout the time, thermal stability and compatibility with other ingredients from this particular formulation.

As an example, in the formulation of the present invention patent application it is possible to use as yellow pigment, methyl yellow or yellow iron oxide; as blue pigment, phthalocyanine blue or sodium aluminum silicate; violet pigment, dioxazine; as green pigment, phthalocyanine; as red pigment, red iron oxide, methyl red, orange benzidine; as white pigment, titanium dioxide; as black pigment, iron and coal oxides, etc. These pigments are commercially available as liquid dispersions or as solid micro powder forms.

The aromatic essences (iii) useful to the ink of the present invention patent application may be chosen from those commercially available, to draw a colors-aromas code suitable to the mnemotechnical guidelines. Those essences recommended to be used in the cosmetic and food industry are suitable for the inks present in the present invention patent application

The inks of the present invention patent application include also a mineral load material (v) embodied to the formulation in order to provide the desired viscosity and ease its application with a brush, spatula or with the hands. For this reason, the inks of the present invention patent application may be packed and commercialized in different presentations with different viscosity.

The loads suitable to the inks of the present invention patent application are those that, in addition to its capacity of increasing the viscosity and/or the ink volume, present a low dying power in such way that there are no significant changes in the color tones. Examples of useful loads are: kaolin (hydrated aluminum silicates), alabaster, calcite (calcium carbonate), gypsum (calcium sulfate dihydrate), alumina (aluminum oxide) and talc (hydrous magnesium silicate). In the preferred embodiment of the ink of the present invention patent application, the load is the calcium carbonate.

The inks of the present invention patent application include a preservative agent (vi) that protects them from bacteria and fungus during the storage period and prolonged usage. For the choice of the preservative agent suitable for the inks of the present invention patent application, it is included those that, in addition to have high bactericide and fungicide action, present the lower level of toxicity and the higher chemical stability which make them compatible with the mixture, preventing that the emulsion denaturalize, and the higher thermal stability taking into account that the manufacturing process of the ink includes a heating stage.

Among others, but with no limitation, examples of preservatives useful to parabens are the 2-bromine-2-nitropropane-1,3-diol, inorganic salts of trans acid, trans-2,4-hexadienoic (sorbic acid) and formaldehyde. The preferred preservatives to the present invention patent application are the alkyl parabens mixture, due to its best fungicide power related to the 2-bromine-2-nitropropane-1,3-diol; best antibacterial action and best thermal stability related to the sorbates, and the lowest toxicity related to the formol. Particularly, the alkyl parabens mixtures have showed that they are more effective to protect these inks against the highest spectrum of fungus and bacteria simultaneously.

The ink present in the present invention patent application does not have antifoam agent, dispersing agent nor moisturizing agent or thickening agent chosen from the industrially available and used in the classic formulations of inks known in the art so far.

### Example 1

### Preferred Formulation

A typical formulation of the present invention patent application, but not solely limited to it, comprises:
Water: 5 to 25%
Glyceryl monostearate: 10 to 25%
Cetostearilic alcohol: 1 to 4%
Polyoxyethylene sorbitan monooleate: 1 to 3%
Vinyl glue (aqueous emulsion of vinyl acetate homopolymer): 25 to 60%
Pigments: 0.2 to 5%
Aromatic Essences: 1 to 6%
Parabens: 0.5 to 1%
Calcium carbonate: 5 to 20%

Toxicity. Regarding to the levels of toxicity of the formulation compounds previously disclosed, even if it is clear that they depend on the data provided by the supplier itself in each acquired portion, the skilled in the art may access the Safety Data Sheet corresponding to the general case of food and/or cosmetology commercial products. It can be easily proved to all of them that in the concentration values used in the formulation, none of them overcomes the levels of safety to the inadvertent ingestion. Notwithstanding and with a further safety aspect, the inventor embody to the formulation the sanitarily recommended amount of bitter substances, such as, denatonium benzoate or Bitrex®, according to the local toxicity standards in force, in order to prevent inadvertent or involuntary ingestion by human beings.

### Example 2

### Drying Time Test

Such as it was previously indicated, the ink of the present invention patent application has showed excellent property in the drying time that makes it distinctive regarding to the ones that are generally used in the art to the same purpose.

Material. Three different-natured material were chosen, being two of them the most routinely used by artists, canvas and cardboard primed, and the third, the most used in didactics activities with children, paper. The cardboard was chosen primed with linseed oil and the canvas primed with water-based ink. The inks of the test were applied over them in squared areas of a surface with 25 cm², in some of them a thin layer was applied, of 0.2 g of ink (superficial density=0.008 g/cm²) and in others a thick layer of 0.5 g of ink (superficial density=0.02 g/cm²), resulting on a ratio between the layers compared to at least 2.5 times higher one from another.

Such as it is known in the art, the term “priming” used in the present description relates to the preparation that is given to a material in order to obtain excellence in the artistic work. This preparation consists in the application of a product over such material (canvas, cardboard, etc.) that allow the ink to fix properly to it and prevent transparency and other undesired and adverse effects to the production of the artistic work.

Humidity. Two drying conditions from different environmental humidity were also chosen; condition A: 75% to the case of the tests in thin layer (0.008 g/cm²), and condition B: 95% to the case of the tests in thick layer (0.02 g/cm²).

Ink. On the one hand, it was used a sample of the ink of the present invention patent application prepared according to the formulation disclosed in the Example 1 and, on the other hand, an oil-based ink commercially available from the brand Gato Preto® from Sutho Ltda, Colombia. Both inks were applied without adding any solvent.

Drying. It was performed under “free air” under the controlled humidity conditions according to the previous paragraph. It was established as criteria of “dry ink” that one in which the ink applied does not detach or stain when touched.

Results. Table I shows the results obtained where the drying time decrease is proved.

TABLE 1

| | | | Ink of the present | |
|---|---|---|---|---|
| | | | invention patent | |
| | Oil-based ink | | application | |
| | condition A | condition B | condition A | condition B |
| | hum.: 75% | hum.: 95% | hum.: 75% | hum.: 95% |
| Material | s.d.: 0.008 g/cm² | s.d.: 0.02 g/cm² | s.d.: 0.008 g/cm² | s.d.: 0.02 g/cm² |
| Paper | 135 minutes | 47 hours | 10 minutes | 25 minutes |
| Cardboard primed | >5 days | >5 days | 70 minutes | 180 minutes |
| with linseed oil | | | | |
| Canvas primed | 440 minutes | >5 days | 30 minutes | 50 minutes |
| with water-based | | | | |
| ink | | | | |

The ink of the present invention patent application with the formulation previously described is advantageous regarding to the existing state of the art and its advantages are summarized below:

It provides an innocuous, stable, suitable product to the artistic expression, which is based on offering to general artists and, especially, to the visually impaired people and to children a way to connect with the artistic world.

It provides, in the case of visually impaired people, a particular and synergic way to connect with the color through the senses unaffected by their visual impairment: the sense of smell and touch, where each color is added with different aromatic substances that, through its chemical compounds, are perfectly miscible with the other compounds of the product. The product is excellent to reach the inserting of the visually impaired people into the world of art.

It provides the highest warranties from the sanitary point of view. The inks presents an outline whose formulation also allows its use by children, with no risk, due to all of its constituting elements (water, calcium carbonate, vinyl polymers, pigments, aromatic substances and authorized preservatives) are completely nontoxic.

It includes the creation of a color-aroma-symbolism-(texture) correspondence through which a visually impaired person may be able to know what color is each ink, simply knowing the convention that bounds the colors to the aromas, what makes that the visually impaired people may use them by themselves, with no need of other's people help. The very special consistence of the product allows the creation of slots in it when it is still wet, so that artists, being visually impaired or not, if desire, may choose to “write” on their work the color codes of the Constanz System. Thus, after have been able to ink a inking autonomously, a visually impaired person may share the colors of their work with other visually impaired ones, once it is very simple to impress the color code in the ink. The product, in this sense, admits several improvement options, such as the ones provided herein, when add to the ink mass texturizer products of different geometric and/or particle size distribution forms that also improve the color-aroma-symbolism-texture synergy and improve the artist-art “dialog”.

Definitely, this product is a suitable and powerful tool that would provide to artists, visuals or not, at any age, a total independence to express themselves through the art.

The methods, processes and apparatuses to the preparation of the inks of the present invention patent application following the previous formulation are performed upon the conventional industrial and/or handcraft techniques known by the skilled in the art.

Formulations of inks to artistic expression on a cosmetic emulsion-base containing all the elements described, innocuous, miscible, homogeneous and stable, prepared, packed with special capacity and suitable to visually impaired people were not found in the previous art. The inventor sustain that the user to which it is designed mainly the product of this invention patent application forms an active part of the synergy, that is required to give a higher inventive projection to the present invention patent application. The product described herein has a direct impact on the improvement of the culture level of a society, once it contributes to an integration of the impaired members of the society as well as untimely stimulates the development of the art, what constitutes a tool and an exclusive, unique and biunivocal solution (art-artist).

Those skilled in the art referred herein will appreciate that other usages of the formulation of the ink disclosed herein by other groups of people, or other activities where this material may be part of other didactic or artistic usages from which a particular reference is given to the properties described in the previous paragraphs, are not apart from the scope of the present invention patent application.

1. “NONTOXIC INK SUITABLE FOR ARTISTIC OR DIDACTIC EXPRESSION”, comprising a cosmetic emulsion and containing at least one emulsifying agent and a solvent; a vinyl or acrylic emulsion; colour pigments; aromatic essences; mineral load; at least one preservative agent, wherein the components thereof are selected from the following groups: (i) for cosmetic-type emulsion from the group consisting of glyceryl monostearate, cetostearilic alcohol, cetyl alcohol, isopropyl myristate, silicones, vaseline, ethoxylated lanolin, acetylated lanolin alcohol, acetylated and ethoxylated lanolin alcohol, stearic acid, linseed oil, vegetable oils; (ii) for emulsifying agent from the group consisting of glycerides of fatty acids, soy lecithin, sucrose esters, propylene glycol esters of fatty acids, stearyl-2-lactic acid, stearyl tartrate, sodium or calcium caseinates; (iii) for resin emulsion from the group consisting of vinyl polymers or acrylic resins; (iv) for mineral load from the group consisting of hydrated aluminosilicates (kaolin), alabaster, calcite (calcium carbonate), gypsum (calcium sulfate dihydrate), alumina (aluminum oxide), talc (magnesium silicate hydrate); (v) for preservative agent from the group consisting of parabens, 2-bromime-2-nitropropane-1.3-diol, inorganic salts of trans,trans-2.4-hexadienoic acid (sorbic acid); and (vi) for solvent from the group consisting of inorganic polar protic solvents.

2. “NONTOXIC INK SUITABLE FOR ARTISTIC OR DIDACTIC EXPRESSION” according to claim 1, wherein the preferred components to generate the cosmetic-type emulsion are a mixture of glyceryl monostearate in a concentration between 10% and 25% (by weight) and cetostearilic alcohol in a concentration between 1% and 4% (by weight).

3. “NONTOXIC INK SUITABLE FOR ARTISTIC OR DIDACTIC EXPRESSION” according to claims 1 and 2, wherein the supporting emulsifying agent to generate the cosmetic-type emulsion is a polyoxyethylated sorbitan mono- or diglyceride, more preferably, a polyoxyethylene sorbitan monooleate in a concentration between 1% and 3% (by weight).

4. “NONTOXIC INK SUITABLE FOR ARTISTIC OR DIDACTIC EXPRESSION” according to claim 1, wherein the preferred vinyl resin is an aqueous emulsion of a homopolymer of vinyl acetate in a concentration between 25% and 60% (by weigh).

5. “NONTOXIC INK SUITABLE FOR ARTISTIC OR DIDACTIC EXPRESSION” according to claim 1, wherein the preferred preservative agent is a mixture of alkyl parabens in a concentration between 0.5% and 1% (by weight).

6. “NONTOXIC INK SUITABLE FOR ARTISTIC OR DIDACTIC EXPRESSION” according to claim 1, wherein the polar protic solvents is water in a quantity not less than 5% and not more than 25% (by weight).

7. “NONTOXIC INK SUITABLE FOR ARTISTIC OR DIDACTIC EXPRESSION” according to claim 1, wherein the aromatic essence is in a concentration between 1% an 6%, the color pigments in a concentration between 0.2% and 5% and the mineral load in a concentration between 5% and 20% (by weight).

8. “NONTOXIC INK SUITABLE FOR ARTISTIC OR DIDACTIC EXPRESSION” according to claims 1, 2, 3, 4, 5, 6 and 7, wherein it is useful for general artistic and/or didactic expression, particularly suitable for artistic and/or didactic expression of visually impaired people, and particularly suitable for artistic and/or didactic expression of children.
